(19) United States
(12) Patent Application Publication
(10) Pub. No.: US 2013/0246084 A1
(43) Pub. Date: Sep. 19, 2013

(54) VERSATILE AND INTEGRATED SYSTEM FOR TELEHEALTH

(71) Applicants: Bambang Parmanto, Pittsburgh, PA (US); Andi Saptono, Pittsburgh, PA (US); I Wayan Pulantara, Pittsburgh, PA (US); I Gede Wira Pramana, Pittsburgh, PA (US)

(72) Inventors: Bambang Parmanto, Pittsburgh, PA (US); Andi Saptono, Pittsburgh, PA (US); I Wayan Pulantara, Pittsburgh, PA (US); I Gede Wira Pramana, Pittsburgh, PA (US)

(73) Assignee: University of Pittsburg - Of the Commonwealth System of Higher Education, Pittsburgh, PA (US)

(21) Appl. No.: 13/643,490

(22) PCT Filed: Apr. 15, 2011
(86) PCT No.: PCT/US2011/032692

§ 371 Date: May 23, 2013

Related U.S. Application Data
(60) Provisional application No. 61/324,897, filed on Apr. 16, 2010.

(51) Int. Cl. G06Q 50/22; G06Q 30/00

(52) U.S. Cl. CPC G06Q 50/22; G06Q 30/01
USPC 705/2

(57) ABSTRACT

A versatile and integrated system for telehealth and/or telerehabilitation which is an architecture or platform for developing various telerehabilitation applications is provided. The system can be designed to take into account the environments and requirements of health-related services. The requirements considered in the platform design include minimal equipment beyond what is available in many rehabilitation settings, minimal maintenance, and easy to setup and operate.

### CROSS-REFERENCE TO RELATED APPLICATIONS

This application claims the benefit of U.S. Provisional Patent application Ser. No. 61/324,897 entitled “VERSATILE AND INTEGRATED SYSTEM FOR TELEREHABILITATION” and filed Apr. 16, 2010. The entirety of the above-noted application is incorporated by reference herein.

### NOTICE ON GOVERNMENT FUNDING

This invention was made with government support under a grant awarded by the National Institute on Disability and Rehabilitation Research (NIDRR), project #H133E040012, project #H133E980025, and project # H133A021916. The government has certain rights in the invention.

### BACKGROUND

With the continued emergence of telecommunications and the Internet on the home and mobile computing industries, remote computer access is being used in a variety of remote business functions today. Recently, “telehealth” has emerged as a delivery of preventive, promotive and curative health-related services and information via telecommunications technologies. Today, the term “telehealth” is used to describe a wide variety of services ranging from two health professionals discussing a patient via telephone to a more complex scenario that employs videoconferencing systems between providers at facilities at different parts of the world.

In real-time telehealth, a telecommunications link, e.g., Internet link, facilitates instantaneous interaction between medical professionals and patients. Conventionally, telehealth has been limited to videoconferencing as one of the most common forms of synchronous telemedicine. As equipment and communications networks increase in capability and lower in cost, direct two-way audio and video streaming between healthcare professionals and patients is continuing to become a viable source of healthcare.

In addition to realtime healthcare monitoring, telehealth enables a patient to be monitored between physician office visits rather than merely when in a physician's presence as in conventional healthcare settings. Studies have shown that continued and preventative care via telehealth has a positive impact on reduction of hospital and healthcare visits. Additionally, telehealth enables treatment by and consultation with medical professionals and specialists regardless of physical or geographical locale. This benefit enhances the healthcare experience, increases quality of patient care while, at the same time, lowers costs associated with healthcare.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation, in aspects thereof, comprises a versatile and integrated system for telehealth and, in specific aspects, telerehabilitation, which is a system architecture or platform for developing various health-related applications. It is designed to take into account the environments and requirements of telehealth services. The platform's design includes minimal equipment beyond what is available in many health and rehabilitation settings, minimal maintenance, and is easy to setup and operate. In addition, the platform is designed to be, and includes components that are, able to adjust to different bandwidth, ranging from very fast new generation of Internet to residential broadband connections.

The system is a secure integrated system that is designed to support most all functions required in a telehealth service. It can combine high-quality videoconferencing with augmented video interactions and access to electronic health record or clinical workflow. The system can include other tools necessary for supporting telehealth sessions including stimuli presentation and patient response, medical devices and clinical camera plug-n-play, enhanced control of the remote environment, archiving with clinical-context annotation and retrieval, interactive sharing and collaboration of applications and clinical materials, and mechanism for locking clinical room. The augmented video interactions can include embedded camera control and image capture, in-situ remote video annotation, teleprompter, and quick note. The architecture of the system is suitable for supporting low-volume services to homes, yet scalable to support high-volume enterprise-wide telehealth services.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example telehealth system architecture in accordance with an aspect of the innovation.

FIG. 2 illustrates an example component diagram of a clinician station in accordance with aspects of the innovation.

FIG. 3 illustrates an example component diagram of a patient station in accordance with aspects of the innovation.

FIG. 4 illustrates an example operating environment in accordance with aspects of the innovation.

FIG. 5 illustrates an example operational overview in accordance with aspects of the innovation.

FIG. 6 illustrates an example welcome screen that prompts authentication in accordance with aspects of the innovation.

FIG. 7 illustrates an example graphical user interface (GUI) in accordance with aspects of the innovation.

FIG. 8 illustrates an example videoconference layout in accordance with aspects of the innovation.

FIG. 9 illustrates an example videoconference layout that incorporates stimuli in accordance with aspects of the innovation.

FIG. 10 illustrates an example stimuli tablet (left) and real time response (right) in accordance with aspects of the innovation.

FIG. 11 illustrates extensibility of the innovation having a variety of cameras and devices in accordance with the innovation.

FIG. 12 illustrates remote layout control in accordance with aspects of the innovation.

FIG. 13 illustrates an example implementation that employs a retinal camera in accordance with aspects of the innovation.

FIG. 14 illustrates a block diagram of a computer operable to execute the disclosed architecture.

FIG. 15 illustrates a schematic block diagram of an exemplary computing environment in accordance with the subject innovation.

### DETAILED DESCRIPTION

As used in this application, the terms “component,” “station,” “server,” “layer,” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. It is to be appreciated that the innovation described and claimed herein can be facilitated via a component (or group of components) or a system designed for the same.

While certain ways of displaying information to users are shown and described with respect to certain figures as screenshots, those skilled in the relevant art will recognize that various other alternatives can be employed. The terms “screen,” “screenshot,” “web page,” and “page” are generally used interchangeably herein. The pages or screens are stored and/or transmitted as display descriptions, as graphical user interfaces, or by other methods of depicting information on a screen (whether personal computer, PDA (personal digital assistant), smartphone, mobile telephone, tablet, pad, or other suitable device, for example) where the layout and information or content to be displayed on the page is stored in memory, database, or another storage facility.

Following is an overview of the innovation to provide perspective to the innovation—it is to be understood that this overview is not intended to limit the scope of the innovation in any way. As described herein, in aspects, the innovation is an interactive platform for telehealth (TH) and collaborative applications. While aspects describe a system designed as a generic platform for delivering telerehabilitation (TR) services, other TH implementations are contemplated and intended to be included within the scope of this disclosure and claims appended hereto. The system is designed to take into account TH and TR services' environments and requirements, including minimal equipment and maintenance, low cost of investment, and ease of setup and operation. Generally, the innovation is a full-fledged TH platform for delivering health services, providing education for healthcare professionals, and for facilitating biomedical research across distances.

In operation, the system is versatile and designed to be able to adjust to different (and/or variable) bandwidths, ranging from the very fast new generation of Internet to residential broadband connections. The system architecture and platform is suitable for supporting low-volume services to homes, yet has the flexibility and capability of supporting high-volume enterprise-wide TH services. The system is also designed to be open and extensible, thereby making it possible to work with various devices and software applications to support TH and collaborative applications.

As described herein, the innovation is a secure integrated system that can combine high-quality videoconferencing with access to electronic health records and other key tools in TH such as stimuli presentation and patient response; augmented video control that includes embedded remote camera control and in-situ video annotation; medical equipment and clinical camera plug-n-play; enhanced control of the remote environment, including remote control of the display screens on the patient site, archiving with clinical context and annotation, interactive sharing of clinical application and material, and mechanisms for “locking” virtual clinic rooms.

The basic configuration of components includes computers (e.g., laptop, desktop, tablet, smartphone, etc.) and web-cameras. In aspects, the hardware component on a clinician station is a desktop computer and a webcam mounted on top of a monitor. The hardware components on the patient station include a similar desktop computer and multiple cameras. The same monitor mounted with a webcam can be used as the primary face-to-face camera. In operation, the clinician can control the zoom of the primary camera as well as the wide angle/wide screen mode to provide a wider view of the patient's environment. A second observational camera can be equipped with a mechanized motor base to allow pan and tilt in addition to the digital zooming capability. This capability allows clinicians to control the viewing angle of the camera remotely.

As an integrated system for TH, the system is designed to support many tasks related to TH services. For example, a list of capabilities include the following:

I. Augmented Video Interaction for TH

Videoconferencing is a key component of most telemedicine applications. In aspects, the augmented video interaction of the innovation is designed to provide clinician better control of video streams to match or surpass the face-to-face clinical sessions. The augmented video interaction for TH includes: (a) Embedded remote camera control; (b) Dynamic in-situ remote-video annotation; (c) Embedded image capture; (d) quick note; and (e) teleprompter.

A. Embedded Remote Camera Control

Camera control is a critical element for many TH applications. The innovation allows clinicians to naturally control the video screens using touch or mouse by directly controlling the screen, e.g., to zoom, pan, or tilt. The embedded control of the innovation provides more natural interaction for clinician and provides a metaphor of videos as window screen to the remote patient, instead of as a camera.

One scenario of the innovation employs two (or more) cameras on the patient side; one camera for face-to-face communication and another to serve as an observational camera. The face-to-face camera is used to support videoconferencing communication, while the observational cameras can be used for focus observations such as hand tremors and non-verbal behaviors. Typically, only clinicians can control the remote cameras, and the camera control protocol in the system defines from which sites the cameras can be controlled.

B. Dynamic In-Situ Remote-Video Annotation

The innovation provides users (e.g., clinicians) with the ability to annotate events in the video using voice recognition, touching, navigating or clicking pre-defined set of annotation, or by entering through QWERTY keyboards or the like. The annotation can be dynamically adjusted to the clinical protocol or the type of TH services. For example, for mental health application the annotation can contain basic emotions (such as joy, sadness, surprise, etc.) or can contain complex interpersonal behavior such as the Circumplex model (such as constructive, passive/defensive, aggressive/defensive, etc.). In the case of remote physical evaluation, the annotation can contain such label as limited functional mobility, gait, balance, or skin integrity, etc. The annotation can be labeled in different colors to assist clinicians in labeling. The pre-defined annotation can float over the video screen and can adjust to video screen size and location, providing greater flexibility for clinicians.

C. Embedded Image Capture

The innovation can include image capture capability. This capability allows a clinician to take a snapshot of a diagnostic picture from clinical camera or observational camera. The captured images can be stored and combined into the patient's health records using.

D. Quick Note

The innovation can include a quick note component that can enable a clinician to access and embed pre-designed or pre-written notes, and to combine them with new notes as desired or appropriate.

E. Teleprompter

Teleprompter can provide eye-contact impression which is helpful for a TH session. The innovation provides clinician with the ability to read protocol verbatim while having eye contact with the patients.

II. Integration with Electronic Health Records (EHR) or Clinical Collaboration Portal

The innovation is designed with the capability to be integrated with a clinical portal or EHR. Clinician can retrieve patient records from the EHR prior to or during a TH session and can enter assessment results or data into the EHR system during a live TH session. The portal and EHR can be located on a different server or on a common server as appropriate or desired. The personalized portal provides such services as scheduling appointments and clinical workflow. Inside the portal, a clinician can see his or her schedule, a list of patients, and tasks assigned by a clinical coordinator.

In accordance with the innovation, the clinical portal can be viewed as a novel groupware system to support work and collaboration among clinician team members in providing care to shared patients. To coordinate the care, a clinical coordinator can develop a treatment plan and assign different tasks within the clinical workflow to different clinicians. The portal provides a status update for each step in the workflow that is available to all team members and provides the clinical teams with a discussion tool. The collaboration portal can be accessed independently from outside the system by using a browser to facilitate asynchronous communications among members of the clinical team. This feature allows clinicians to work on clinical documentation outside the live TH sessions.

III. Stimuli Presentation and Patient Response with Tablet and Ink Technologies

A number of clinical procedures such as cognitive assessment involve a combination of stimuli presentation and patient responses to the stimuli. Remote administration of stimuli and responses is demanding. The innovation provides a system that replicates the face-to-face experience that can be implemented by offering stimuli presentation to the remote patient on a tablet or on a display. The clinician can control the presentation of stimuli remotely, while the patient can also review a sequence of stimuli on his/her own depending on the clinical protocol. A patient can respond to the stimuli by drawing on a blank slate or tracing existing pattern and the response will displayed in real time (or near real time) on the clinician station. It will be appreciated that this capability will allow the clinician to provide direction to the patient in real time, an important requirement for tele-assessment applications such as tele-neuropsychology assessment.

Patient response (drawing, tracing patterns, or going over a sequence of stimuli) can be done by using ink technologies. It is to be understood that, in accordance with the innovation, ink technologies allow a user to do drawing or hand writing. The system has the capability for capturing patient responses such as patient drawing and handwriting using a tablet (either tablet computer or tablet drawing such as Cintix™ system) and presenting the responses on the clinician display in real time.

### IV. Medical Devices and Clinical Cameras Plug-n-Play

The innovation can include medical devices or cameras that can be attached to computers such as retinal camera, endoscopic camera, alternative and augmentative communication (AAC) devices, body monitoring devices, pressure map devices, etc. The video interaction innovation such as image capture, embedded camera control, in-situ annotation can be applied to the plug-n-play camera. The data from medical devices can be integrated with the electronic health record.

V. Enhanced Control of the Remote Environment

For a TH to run smoothly and as natural as the face-to-face environment, it is important for the clinicians to have a full control of the sessions with minimal or without help of a technician on the remote patient side, as it is the case with the current practice. The innovation provides the capability for controlling the remote screen layout using either touch or mouse. This innovation allows clinician to select video screens and how they should be presented on the patient side (their sizes and locations). The innovation also allows clinicians to control how the stimuli should be presented: e.g., on the tablet or on the screen.

VI. Archiving with Clinical-Context Annotation and Retrieval

The entire TH session supported by the innovation can be archived along with its annotation. The innovation provides the capability for clinicians to retrieve segments of the session using the annotation as the key. The innovation also allows clinicians to retrieve segments of the session (for example, an annotated video snippet) and insert the snippet into a clinical report.

VII. Interactive Sharing and Collaboration of Applications and Clinical Materials

The innovation is equipped with the capability for sharing most any clinical software application or clinical materials. For example, two or more clinicians can remotely discuss radiological images/movies, work on a diagnosis and annotate a document, while having face-to-face discussion over a videoconference. In other words, two or more clinicians, located a world away from each other, can discuss diagnoses, share applications, and annotate images/documents.

VIII. Clinically-Robust Security and Confidentiality Method.

The innovation can include industry-standard security protocol such authentication, role-based access, and data and video-transmission encryption. The innovation also includes methods for creating a virtual private room by way of mechanism for “locking” the virtual clinical room.

Overall, the innovation is a platform capable of delivering and enabling various interactive TH applications. Its versatility makes it an optimal platform for telehealth models, including, but not limited to:
Teleconsultation, where a clinician or a patient consults with expert clinician, including Emergency Department consultation (ED Consult), second opinion, medical specialty teleconsultation, and outpatient/rural clinic teleconsultation;
Tele-assessment, where clinician(s) remotely assess a patient (alone or with technician or another clinician), such as wheeled mobility assessment, tele-neuropsychology, physical or occupational therapy assessment, adult autistic assessment, skin assessment in dermatology, etc.;
Tele-therapy, in which a patient conducts rehabilitative activities (such as exercise or play) at home while the clinician remotely monitors the performance and can set the course of the therapy;
Tele-coaching, where the clinician interactively provides instruction and participates in the therapy;
Telehomecare and telemonitoring that connects clinicians to patients at home; and
Specialty telehealth such as: teledermatology, teleophthalmology, telepsychiatry, tele-woundcare, etc.

In addition to the above, the innovation discloses a system for use in a hybrid teleconsultation-teleassessment between two clinicians. Using an observational camera (such as retinal camera), the consulting clinician can see how the remote clinician is performing an evaluation, while at the same time he/she will be able to examine the video image, e.g., via retinal or flexible camera. This will allow the consulting clinician to “see” the patient using the exam camera, while also observing if the remote clinician is performing evaluation correctly. This can be useful for, among other scenarios, ED consultation or assessment of the physician in residency. The image capture will also allow the consulting physician to take diagnostic snapshots from the exam cameras.

As described herein, the functionality of the system can be used with different types of cameras and various USB-, Bluetooth-, firewire; and IR-based devices. This capability is useful for telespecialty applications such as tele-dermatology, tele-ophthalmology, and other teleconsultation between physicians in clinics, community hospitals, or international facilities and consulting physicians in tertiary facilities.

In embodiments, a retinal camera can be used with (or included within) the system. By combining a retinal camera and a regular webcam, a remote clinician and on the other side, the patient and the clinician, can see the details of the eye. Examples of the application of this scenario include a resident in an ER (emergency room) consulting with a remote ophthalmologist. Using this system, the remote ophthalmologist is able to see the inside of the patient's eye, at the same time observing if the resident is performing the exam correctly. Another scenario describes two (or more) consulting ophthalmologists located in different places who can discuss observation with a remote clinician while looking at the same image.

The system is capable of taking high-quality snapshot pictures from remote camera observation. The innovation can also be combined with (or include) a portable camera such as the flexible hand-held examination camera (such as the Total Exam™ camera) for various applications. The snapshot pictures can be included in the Electronic Health Record system and retained as desired, e.g., upon a secure TH server. Clinical applications of this technology include, but are not limited to, wound care and tele-dermatology.

The remote administration of assessment protocols through use of interactive videoconferencing between a patient/client and a remotely located assessment expert can be used in physical, behavioral, cognitive, and mental health. Oftentimes, this assessment is referred to as teleassessment. In some scenarios, teleassessment and TH has value in improving access to services for underserved and rural clients. The innovation combines interactive videoconferencing with integrated teleassessment functions including, but not limited to, presentation of stimuli, electronically capturing patient's response to stimuli using tablet, scoring, data storage, and report generation. The system also supports and provides for sharing into an integrated and intuitive web portal environment.

Telehealth (TH), e.g., telerehabilitation (TR) has been considered as an important technology for increasing accessibility and enhancing continuity of care for vulnerable population, including people with chronic disease and disabilities. The innovation discloses a platform for building TH applications that can take into account the diverse settings and requirements of various healthcare and rehabilitation services. In a specific example, TR refers to the use of information and communication technologies (ICT) to provide remote rehabilitation services such as physical and occupational therapies, cognitive assessment and therapies (traumatic brain injuries, etc.), speech-language therapies, and the provision of assistive technologies (wheelchair, computer access, etc.).

The environment of rehabilitation services is unique as it can take place within the community (home, workplace, long-term care, assisted and independent living) in addition to clinics and hospitals. As will be understood, TR services generally involve various healthcare professionals and diverse diagnoses. TR shares many of the features of chronic disease management where encounters between clinician and the patient is generally repetitive and over a long time period, although the interaction is typically of low intensity. This is in contrast to other telemedicine (or telehealth) applications that require short duration, high intensity interactions.

In general, the conceptual models of TR service delivery can be divided into at least four categories: (1) teleconsultation using interactive videoconferencing; (2) telehomecare with a mobile clinician coordinating service with a low to moderate bandwidth interactive connection; (3) telemonitoring using unobtrusive method with possible interactive teleassessment; and (4) teletherapy in which a patient conducts rehabilitative activities such as exercise or play at home while the clinician remotely monitors the performance and can set the course of the therapy or interactively participate in telecoaching.

Interactive technologies such as videoconferencing and information sharing (both synchronous and asynchronous) comprise the backbone of technologies for supporting models of TH/TR service deliveries. As will be understood, technologies such as immersive virtual reality and haptic interface can be used to support teletherapy. In addition to image-based (e.g., videoconferencing), technologies for physical teletherapy include sensor-based rehabilitation and virtual environments.

One of the traditional obstacles to TH and TR deployment is the fact that the technologies traditionally work in isolation to one another. This situation limits the functionality of the technology and leads to expensive initial investment and cost of operation for deploying a complete TH system. For instance, considering that the number of patients at a rehabilitation site (e.g., home) is often only one or a few patients, the cost is oftentimes prohibitive.

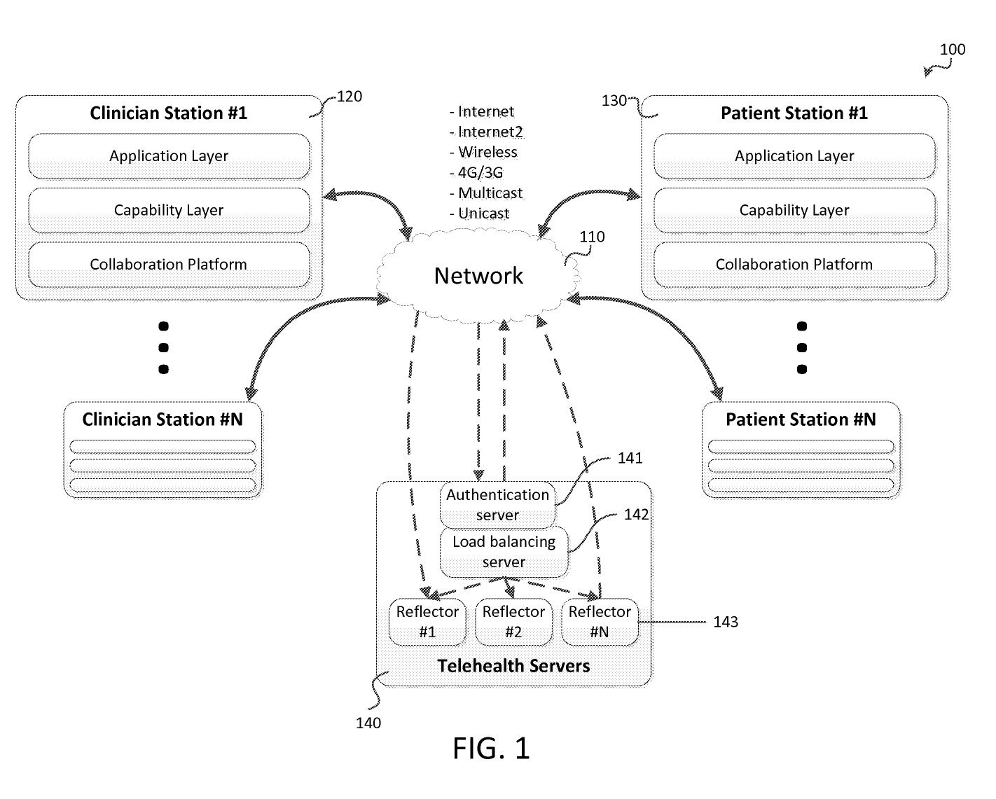

Referring now to the figures, as shown in FIG. 1, the innovation's system 100 employs components and a network (e.g., the Internet) to develop a platform that can be used as a backbone for delivering various rehabilitation services across different service delivery models. The platform is designed as an integrated system that goes beyond the conventional videoconferencing traditionally used in telemedicine by incorporating functions that are useful for TR, and TH generally.

As illustrated, the TH system 100 includes 1 to N, where N is an integer, clinician stations 120 and 1 to N, where N is an integer, patient stations 130, including a Clinician Station #1, a Clinician Station #2, and so forth to a Clinician Station #N; and Patient Station #1, Patient Station #2, and so forth to a Patient Station #N. It is to be understood that the number of clinician stations 120 need not match the number of patient stations 130. For example, in aspects, a larger number of clinician stations 120 can be employed to monitor a single patient station 130.

In operation, each of these clinician stations 120 and patient stations 130 can be connected or coupled (e.g., wired or wireless) to a computer network 110. In aspects, the network 110 can be the Internet or Intranet, and can be Unicast or Multicast, among others. The clinician and patient stations (120, 130) can be connected to the network 110 by wired, wireless (e.g., Wi-Fi, Bluetooth), by cellular network (e.g., 3G or 4G), etc., or any combination thereof. The platform or system 100 can be configured to operate on a variety of networks 110 ranging from fast network such as the Internet2, or a slow network of DSL (Digital Subscriber Line), for example in home environments. Additionally, the platform in clinician and patient stations 120 and 130 can have the capability to adjust to different bandwidths, ranging from the very fast new generation of Internet1 to residential broadband connections or the like. It will be understood that this capability enables the system 100 to adapt to most any network connections and bandwidths available.

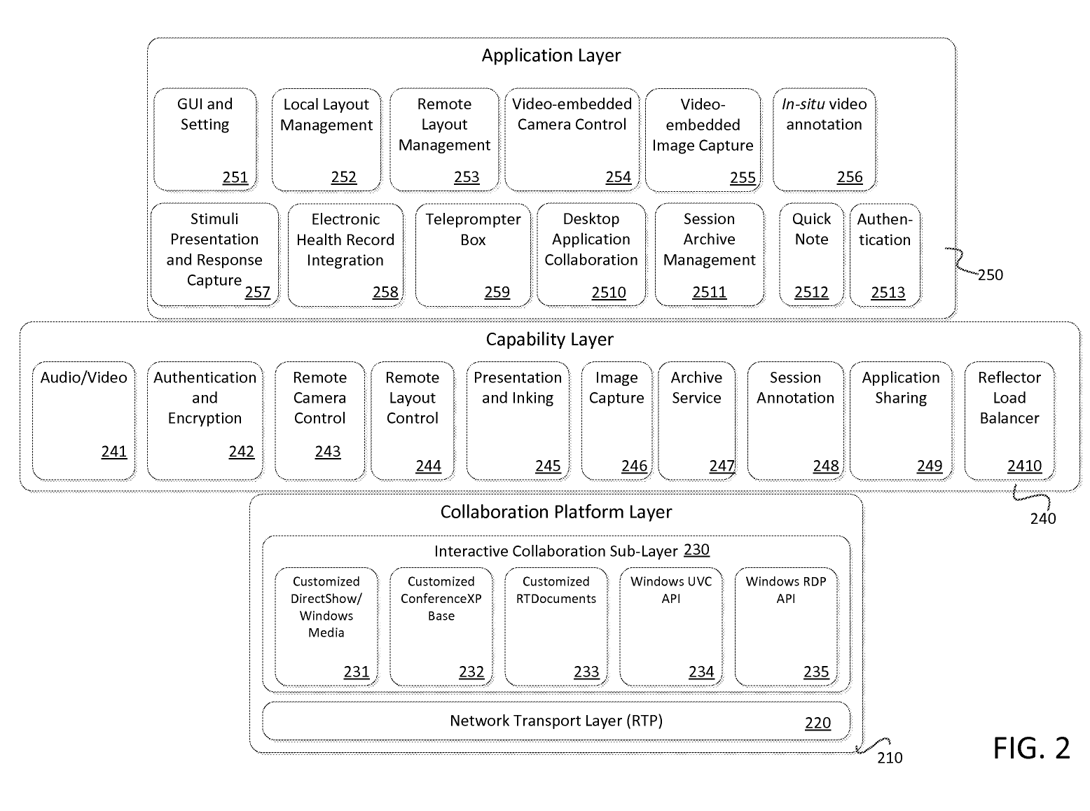

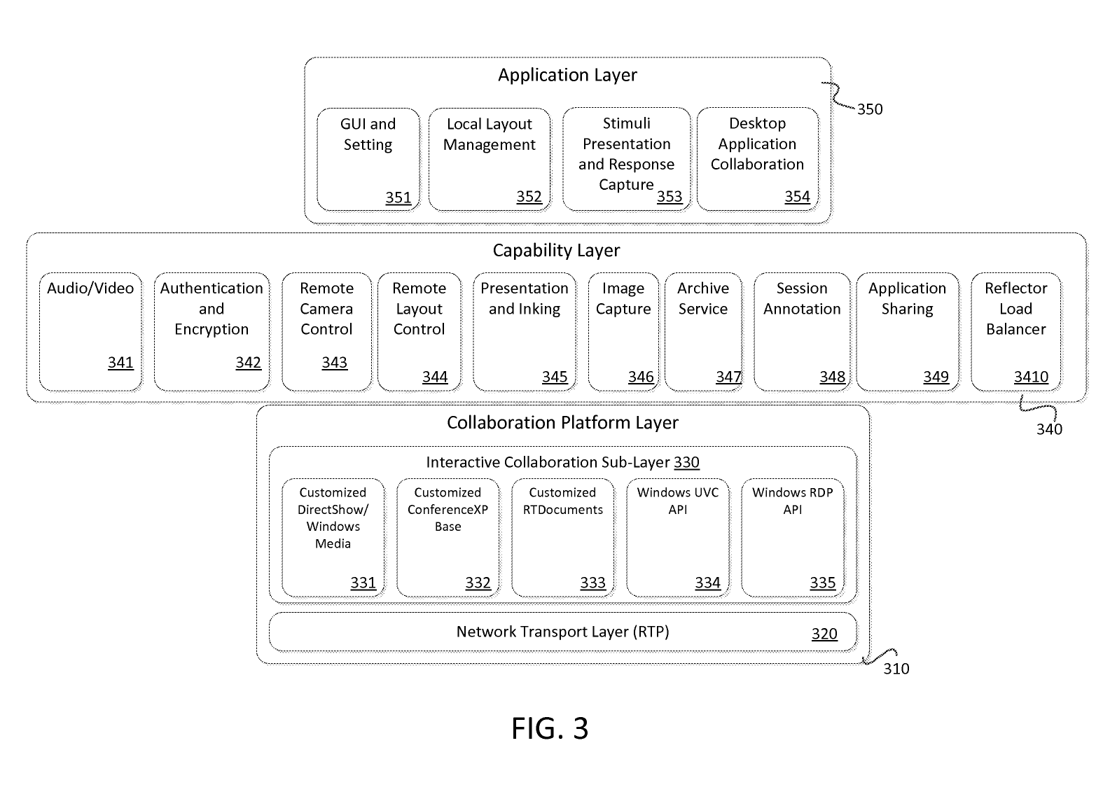

As shown in FIG. 1, each of the clinician and patient stations (120, 130) includes a telehealth platform, having application, capability, and collaboration platform layers which facilitate remote communication and telehealth features, functions and benefits as described herein. In aspects, the TE platform components on the clinician station 120 are different from those on the patient station 130 and shall be described with reference to FIG. 2 and FIG. 3 infra In operation, the platform on the clinician and patient stations (120, 130) can connect to virtual clinic rooms by logging in to the authentication server 141. Thus, only authorized users can access the clinic rooms. Further, it is to be appreciated that virtual room access can be regulated or otherwise controlled by users with applicable authority. In one aspect, a clinician can enter a room with a patient and thereafter virtually “lock” the room prohibiting access by other users.

In other words, the authentication server 141 also provides clinic room management for system administration related to create virtual clinic room and defines who has access to the room, who can lock the room, etc. In aspects, user authentication, communications between clinician and patient stations (120, 130), data (e.g., healthcare record) retrieval, etc. can be encrypted, for example using a symmetric encryption key.

As shown, the clinician and patient station(s) (120, 130) can be connected to the network 110 through a multicast capable network or unicast-only network. If any of the stations (120, 130) are connected using a unicast network, the station could employ a reflector server in order to connect to other stations in the system 100. In aspects, the innovation employs an array of computing devices as reflector servers 143, reflector #1 to reflector #N, where N is an integer. The same computing device of 141 or another computing device 142 can act as a load balancing server. In the aspect of FIG. 1, a load balancing application in the clinician and patient stations will work with the load balancing server 142 to locate an optimal reflector from the array of reflectors 143 #1 to #N.

In aspects, the system 100 provides an initial list of useful features, including, but not limited to, remote camera control, secondary camera control, videoconferencing with high level data compression, secure access to health records, and collaboration among clinicians and caregivers. Rehabilitation and chronic care management usually involves collaboration among an interdisciplinary group of providers (e.g., rehabilitation professionals, physiatrists, neurologists, psychologists, assistive device suppliers, etc). ICT has been viewed as a potential solution to the problems of collaborative care either in continuity of care or in fragmented care environments. The platform of the innovation is also extensible, capable of incorporating new devices, functions, or new technologies as desired.

In addition to being integrated and extensible, one goal of the innovation is to develop a platform that is versatile in a number of ways. First, the system 100 includes minimal equipment beyond the standard commodity computers to minimize the initial investment cost. Second, the system 100 is easy to install and to operate. This is not only to minimize the maintenance cost, but also to address the fact that the facilities usually have no ICT support staff. The fact that the system 100 can be easy and quick to setup will also address the issue of low volume services to many healthcare and rehabilitation settings. The system 100 can support low-volume TH and TR to various locations in a scattered geographic area. Third, as described supra, the system 100 can adjust to different network (110) bandwidths, ranging from very fast new generation of Internet (e.g., Internet2) to regular broadband connections available in assisted living and home residencies (e.g., DSL).

It is to be understood and appreciated that the terms “patients” and “clients” are used interchangeably in health- and rehabilitation-related fields. The terms patient is used in this specification to avoid confusion with the term client in software client program and to be consistent with the term used in the other branches of telemedicine and telehealth fields.

In summary, the innovation describes a TH and TR platform 100. The platform is designed to work with limited resources that are available in health and rehabilitation settings such as: computers, webcams, and broadband Internet connections. The system 100 is also designed to be easy to use, and requires minimal technical expertise and support. The time and the cost for setting TR services are expected to be minimal since most all of the components (computers, webcam, and Internet connection) are available and can be used for purposes other than TH and TR. At the same time, the system 100 is capable of delivering high-quality interactions (HD (high definition) video and audio) and can be integrated with advanced technologies such as portable medical devices, portal system and electronic health records.

Turning now to FIGS. 2 and 3, example block diagrams of the platform on the clinician and patient stations are shown. The platform consists of collaboration platform layer 210 and 310, capability layer 240 and 340, and application layer 250 and 350. In aspects, the first two layers (collaboration (210, 310) and capability (240, 340)) on the clinician and patient stations (120 and 130 of FIG. 1) are identical. The collaboration platform layer (210, 310) includes sublayers interactive collaboration (230, 330) and Network Transport Layer (220, 320). In an embodiment, the Network Transport Sub-Layer 220 includes the standard Real-time Transport Protocol (RTP), an Internet Engineering Task Force (IETF) standard RF 3550 published in 2003. The Interactive collaboration sub-layer (230, 330) can include a customized version of the Microsoft Windows Media®, and Microsoft DirectX® (231, 331), a customized version of the open-source ConferenceXP libraries (232, 332), a customized version of the Microsoft .NET RTDocument protocol (233, 333), Windows UVC API from Microsoft 234/334, and Windows RDP protocol API from Microsoft (235, 335). It will be understood that each of these components facilitate interactive collaboration in accordance with the innovation.

The capability layer (240, 340) can comprise important software libraries that will be used as a foundation for the development of application layer (250, 350). The capability layer (240, 340) can include the following capabilities: Audio/Video (241, 341), Authentication and Encryption (242, 342), Remote Camera Control (243, 343), Remote Layout Management (244, 344), Presentation and Inking (245, 345), Image capture (246, 346), Archive service (248, 348), Video session annotation (248, 348), Application sharing (249, 349), and Reflector load balancer (2410/3410).

With reference again to FIG. 2, application layer 250 on the Clinician Station 120 contains the full capability of the system. Here, the application layer 120 includes applications that a clinician uses during a telehealth or telerehabilitation session. The graphical user interface (GUI) and setting 251 is the user interface such as ribbon menu on top of the interface, sliding ribbon on the left for venue, and sliding ribbon on the right for electronic health record. While a specific GUI is described, it is to be appreciated that alternative GUIs can be employed without departing from the spirit and/or scope of the innovation.

The local layout management application 252 allow users to change (or customize) the screen layout of multiple video streams using several pre-defined layouts, e.g., 4-way, 9-way, two-way, etc. The local layout management component 252 also allows users to choose which video to focus and which to enlarge (or shrink/fade). In addition, the layout management 252 allows users to move stimuli or presentation to a tablet as desired.

The Remote Layout Management application 253 provides clinician with the capability to control the screen layout of the remote patient station. The function is similar to the local layout function (e.g., sending stimuli to tablet, changing layout, etc.). However, it enables a clinician to remotely control the patient station as desired or appropriate.

The video-embedded camera control application 254 provides the ability for users to control remote cameras as well as local cameras. The video-embedded camera control application 254 has a unique feature of having the control embedded in the video screen and allows users to control the video naturally by zooming, panning, and tilting the remote or local cameras.

The video-embedded image capture application 255 provides users with the ability to take a picture captured from the video streams Most any video stream can be captured by the users using point and click on the video screen. The In-situ video annotation 256 provides users with the ability to annotate events in the video using pre-defined set of annotation by point and click. Other annotation can be inserted using voice recognition, QWERTY keyboards or the like. This application enables a clinician to annotate events quickly and easily without having to write down the annotation.

The stimuli presentation and response capture application 257 is designed to support the remote presentation of stimuli by a clinician in the clinician station (120 of FIG. 1) to patient located in remote patient station (130 of FIG. 1). The stimuli application 257 enables a clinician to send the stimuli to the screen or to the tablet on the remote patient station 130. In operation, the clinician will be able to control the stimuli, e.g., move forward, or backward, and to control the pace, etc. Depending on the protocol, the patient can respond to the stimuli in various ways. One of the possible methods of response is by drawing, writing, or tracing stimuli patterns on a tablet, laptop or other suitable device. In accordance with the innovation, the clinician will be able to observe the patient responses in real-time (or near real-time).

With continued reference to FIG. 2, the electronic health record integration application 258 facilitates integration to an existing electronic health record system, or includes clinical workflow and documentation used to support the TH protocol. For example, for Adult Autistic Assessment service delivery, the electronic health record application contains assessment document with scoring system included. In one aspect, the electronic health record is available on the right ribbon of the system.

The teleprompter box application 259 allows users to achieve eye gaze perception and to support reading verbatim from clinical protocols required in a number of cognitive rehabilitation applications. Using this application 259, users will be able to achieve the impression of eye contact on the other side of the videoconferencing in a desktop environment.

The desktop application sharing 2510 in the system allows two or more parties to share an application. An example of the use of this application sharing is to allow two clinicians to view the same radiology images and to collaboratively annotate the images. The session archive management 2511 allows users to archive the session securely, e.g., on the TH server (140 of FIG. 1). It is to be understood that, the innovation can be limited to archive only upon TH servers (140 of FIG. 1) in order to comply with HIPAA (Health Insurance Portability and Accountability Act) and other regulatory guidelines.

The quick note application 2512 allows clinician to write (or speak) notes which can be saved on the server. It will be appreciated that, in aspects, the notes can be tagged to video for subsequent playback and analysis. As described supra, the authication application 2513 can be used to check and verify user's authentication and to manage user's profile information.

Continuing with the aforementioned example, FIG. 3 illustrates the platform on the patient station (130 of FIG. 1). The application layer 350 on the patient station can include a subset of the applications available on the clinician station, as described supra. As shown, the applications available on the patient station can include GUI and setting 351, local layout management 352, stimuli presentation and response 353, and desktop application collaboration (or sharing) 354. The functionality of each of these components is similar to the like-named components described with reference to FIG. 2.

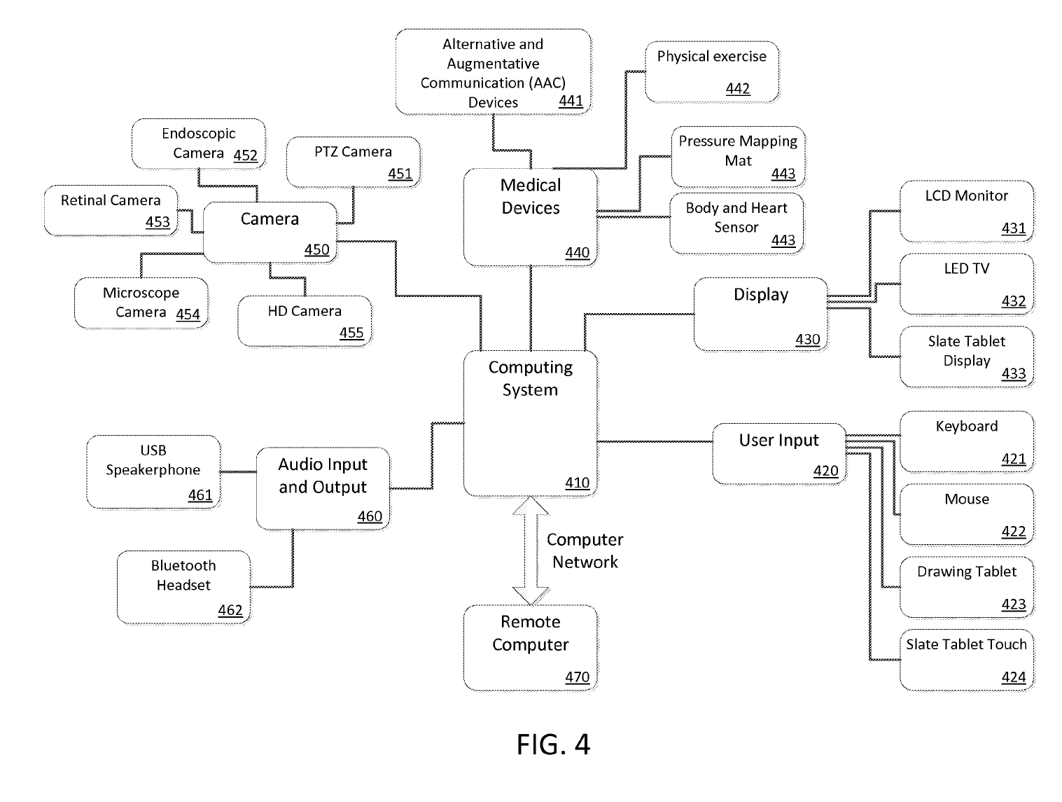

FIG. 4 illustrates an example operating environment in accordance with aspects of the innovation. As shown, the system is designed to operate in a computing environment and on a computing device 410. While an example computing environment in which the system operates is described, it is to be understood that other examples exist that are to be included within the scope of this disclosure and claims appended hereto. The following brief and general description is intended as an example of the operating environment and not intended to limit the innovation in any manner. The system is operational with numerous general purpose or special purpose computing system environments or configuration. Examples of well-known current computing systems include, but not limited to, personal computers, server computers, laptop, netbook, tablet, slate, pad, and smartphones.

In operation, the computing system 410 may be attached with camera device 450 for supporting video system. The innovation can be used with (or include) general purpose camera such as webcam or most any other cameras such as PTZ camera, HD camera, or the like. The innovation can also be used with (or otherwise include) specialized cameras such as endoscopic camera 452, retinal camera 453, and microscope camera 454, etc. It is to be understood and appreciated that the functions provided by the application as explained herein, and specifically in FIG. 2 and FIG. 3 will work with most any of these cameras.

The computing system 410 running the platform can use various medical devices 440 attached to the computing system. The medical devices 440 may include, but are not limited to, alternative and augmentative communication device (AAC) 441, monitoring devices for physical activity and exercise 442, pressure mapping mat for wheelchair users 443, and other body and organ sensors 444. While specific sensory examples are described, it is to be understood that the innovation can employ most any sensor technologies known in the art without departing from the features, functions and benefits of the innovation.

The display unit 430 used for the platform may include a computer monitor 431, TV (television) monitor 432, slate or tablet display 433, projector (not shown), touchpad or touch-sensitive display (not shown) or the like. The user input 420 that can be used with the computer system 410 running the platform may include keyboard 421, mouse 422, drawing tablet 423 for stimuli response, and slate tablet 424. The audio input output 460 may include speakerphone 461 and headset 421 connected wired or wirelessly.

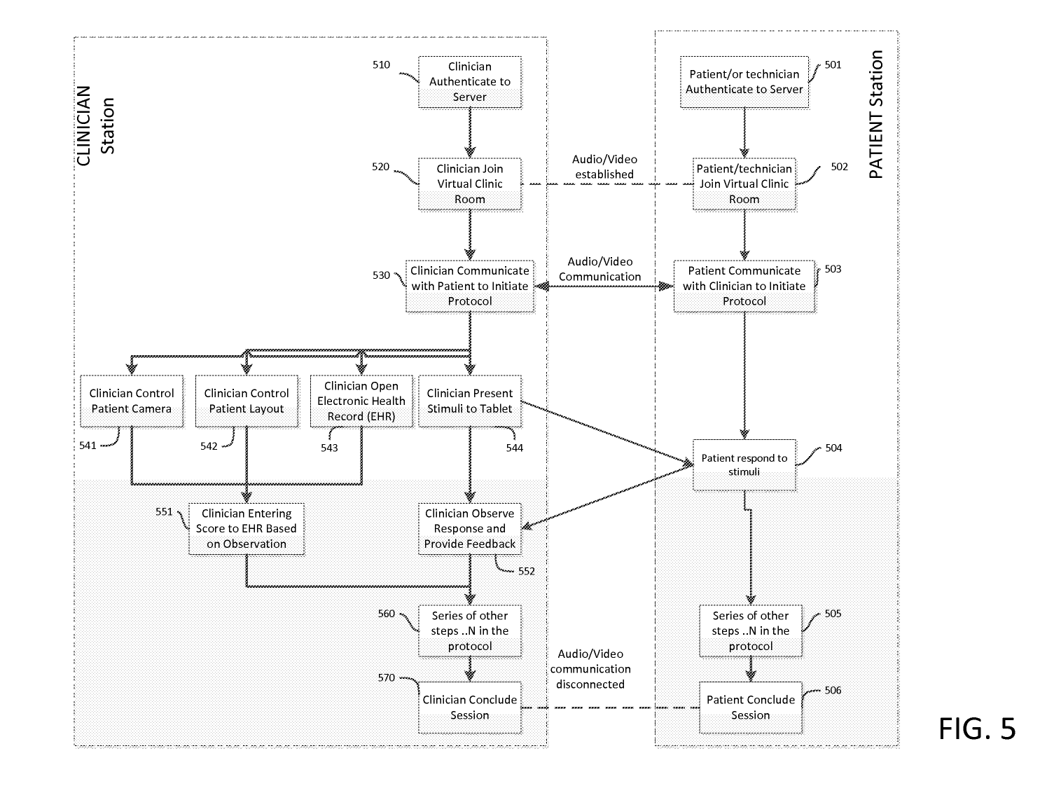

FIG. 5 illustrates an operational overview of the innovation. The operation of the system 100 shown in FIG. 1 is now discussed with reference to FIG. 5.

FIG. 5 is a general flow diagram illustrating an example telerehabilitation session conducted using the platform. It is to be appreciated that there are many ways that a telerehabilitation session can be conducted. This example is only one way in which the system may be used.

A telerehabilitation session begins with clinician station and patient stations (120, 130) connect to the TH server 140 and authenticate their identities (510, 501). On the patient station (130), a technician of a clinic may be the user who logs in instead of the patient. Both sides can then join virtual clinic room (502, 520) that they have privilege (or rights) to enter. A unique feature of the system is that once a telehealth is in session, the clinician will be able to lock the room so that no other users can enter the room, so long as rights exist. This provides a private room for the clinician and patient to conduct a TH or TR session. The result of steps (520, 501) is a face-to-face videoconferencing session. As described herein, the videoconference can be limited by enabling the clinician to virtually “lock” the room. Subsequently, clinician and patient communicate to initiate a TH protocol (530, 503).

On the clinician station, the clinician may control the patient camera 541, e.g., to adjust to the right angle and focus, control the screen layout of the patient station 542, access, retrieval and opening of electronic patient health records 543, and presentation of stimuli to the tablet on the patient station 544. The acts 541 to 544 can be performed without particular order or concurrently as appropriate.

Responding to stimuli presentation, a patient may respond 504 physically or verbally, wherein the response can be observed using camera and audio equipment. In one example, the patient may also respond by drawing or tracing pattern of the stimuli using a tablet. Based on the patient responses, a clinician may observe and evaluate the patient 552. The clinician may also provide feedback to the patient, such as changing the pattern trace or the drawing. The clinician can enter the observation, assessment, or evaluation using the electronic clinical documentation or electronic health record 551. This process can be repeated many times, and a series of other acts may be conducted by clinician and patient (560, 505). Once a TH session is concluded (570, 506), audio and video communication between clinician and patient is concluded.

Following is an operational detail discussion of a working example in order to provide perspective to the innovation. It is to be understood and appreciated that this discussion is not intended to limit the scope of this specification and/or claims appended hereto. Rather, the discussion is provided to add context to the innovation to enable an understanding of the features, functions and benefits described herein. In order to more fully understand the system shown in FIGS. 1, 2, 3, and 4, the operational details of an exemplary operation are presented. It should be noted that this working example is but one way in which the system may be used and that other examples exist.

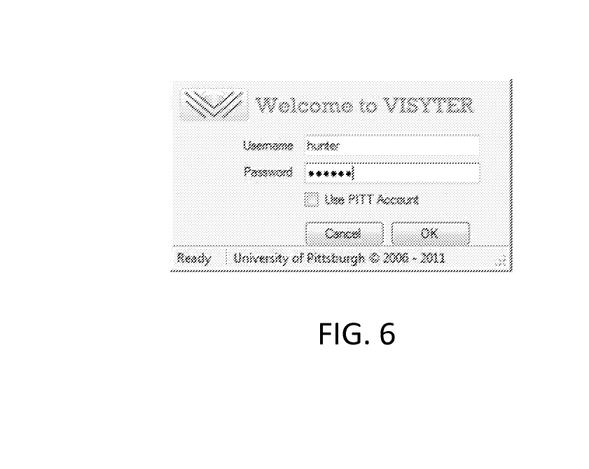

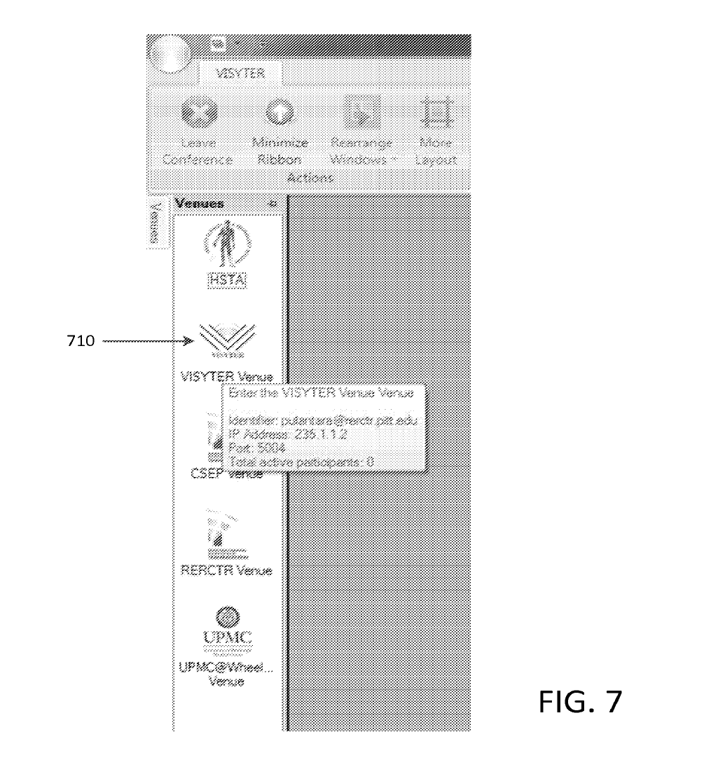

FIG. 6 illustrates a screenshot of an example process of a user accessing the TH server 140 for authentication. As described supra, the data traffic between clinician and patient stations (120, 130) to the TH server 140 can be encrypted using most any suitable encryption algorithms. In one TR aspect, the system can be referred to as a Versitile and Integrated System for Telerehabilitation or VISYTER. Once a user is authenticated, FIG. 7 illustrates a VISYTER user interface where a user can choose from a number of clinic room/venue that she or he has a privilege to enter. Using most any navigation control, a user can select one venue 710 and see other individuals present in the venue before entering.

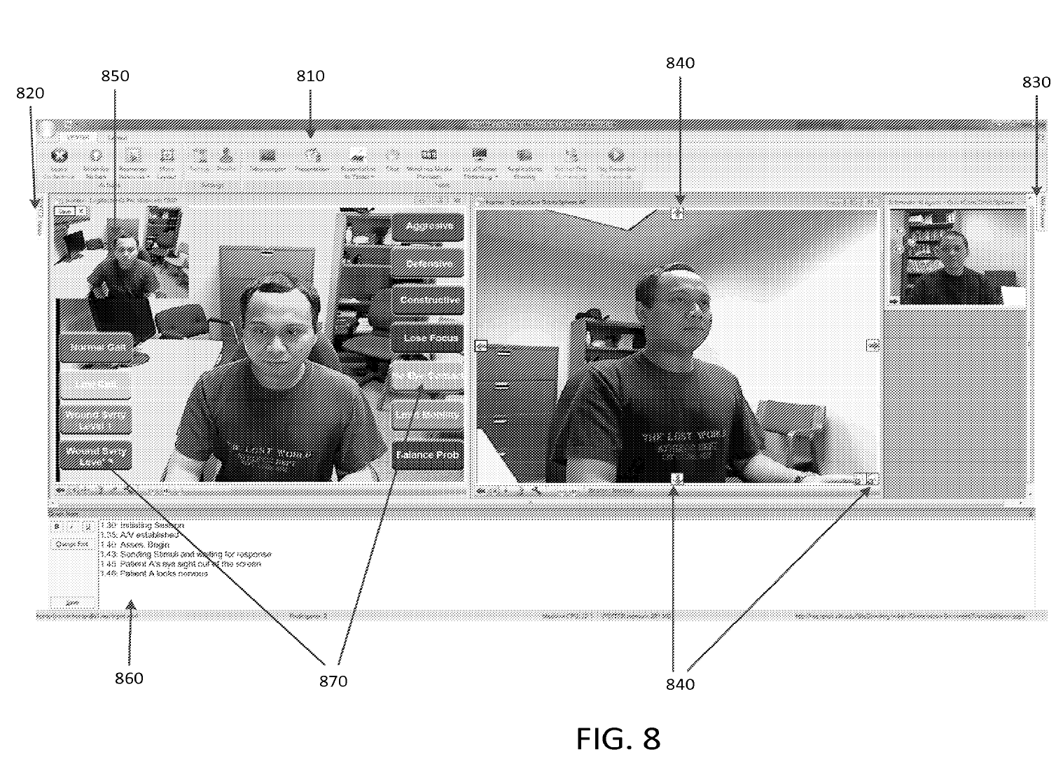

Once a TH or TR session is initiated, a videoconferencing is in session as illustrated in FIG. 8. It is to be appreciated that the configuration, layout and/or orientation of FIG. 8 is but an example—other aspects can employ alternative configurations, layouts and/or orientations without departing from the spirit and/or scope of the innovation described herein. In accordance with the aspect, the primary menu ribbon is illustrated in 810, while the clinic room ribbon is on the left 820, and electronic health record ribbon is on the right 830. Two video streams from patient station and one stream from clinician station is illustrated. An embedded camera control 840 is illustrated.

In accordance with camera control 840, the user can manipulate the video directly to control the camera, instead of using different menu button or remote control device which is the common practice in traditional videoconferencing systems. An embedded image capture 850 is illustrated to show that a user can take a picture, remotely or locally, by directly manipulating the video screen in lieu of using menu button or remote control device which is the common practice in conventional videoconferencing systems. Quick notes for a clinician is illustrated in 860 to allow clinician to write observation that is not port of the standard protocol. As described supra, voice capture and voice recognition can also be employed to enable quick notes functionality.

A dynamic in-situ clinical video annotation system 870 is also illustrated in FIG. 8. This dynamic in-situ clinical annotation allows clinicians to annotate events in a TH session according to a pre-defined labels relevant to the protocol in session, e.g., via a navigation tool such as a mouse, touchpad, rollerball or the like. It is to be understood that the label can dynamically float over the video screen and can adjust to the video screen size and location. It is to be understood that the labeling system can be changed or modified according to the protocol. The in-situ labeling system allows clinicians to annotate clinical events with less effort and allow them to focus on the patients, instead of on note-taking. Further, the in-situ annotation can be used with a live session or with recorded sessions.

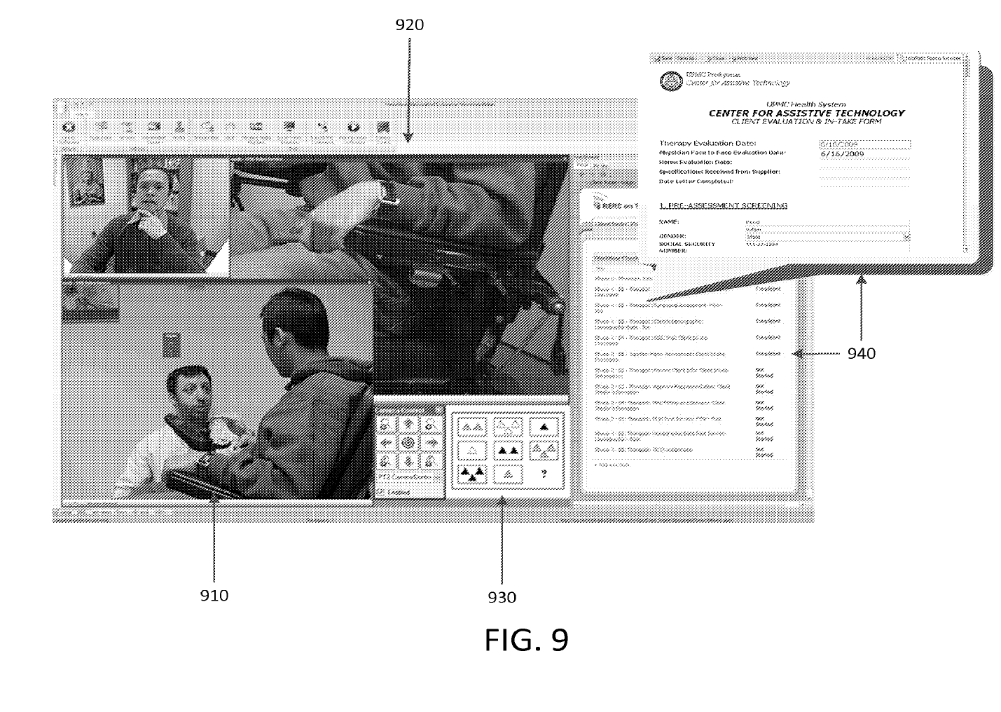

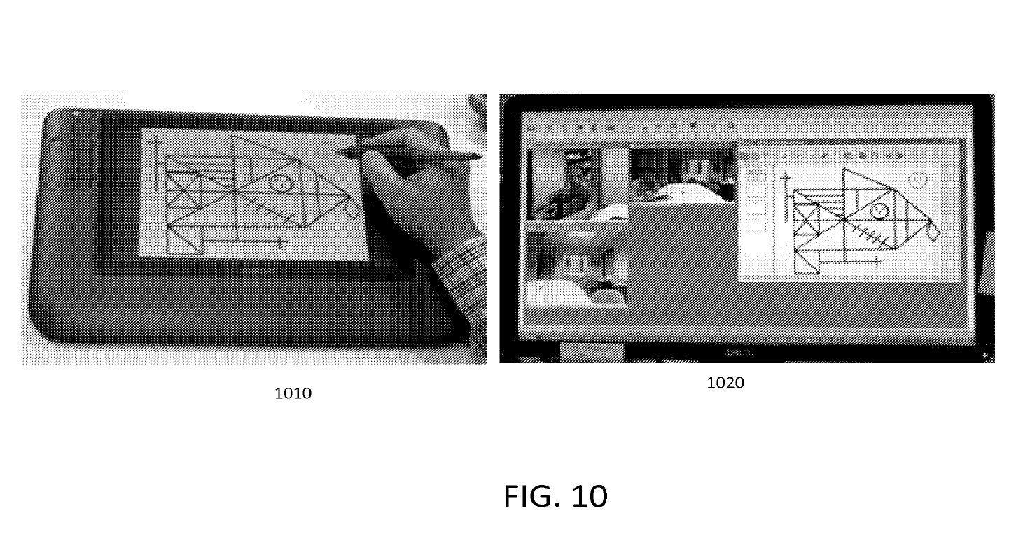

FIG. 9 illustrates the capability of the innovation for supporting the entire TH or TR protocol by integrating stimuli presentation 930 and electronic health records (EHR) or clinical documentation 940 inside the platform, while engaging patient in a videoconferencing session using two (or more) cameras 910 and 920. The capability of the innovation for supporting the entire TH protocol is also illustrated in FIG. 10, where patient response 1010 on the tablet can be observed by clinician 1020 in real time (or near real time).

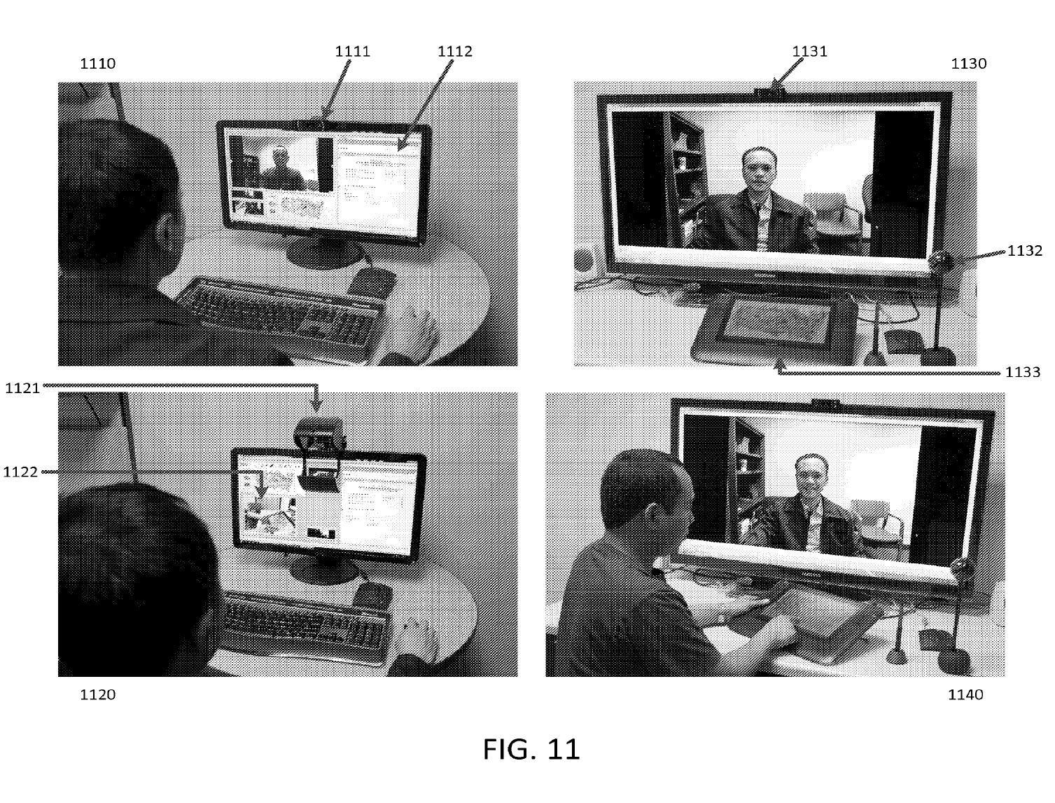

Referring now to FIG. 11, illustrated is a TH working environment with 1110 and 1120 representing a clinician station, and 1130 and 1140 representing a patient station. In the clinician station, the clinician can employ a face-to-face camera 1111, and opening clinical documentation 1112 while in a videoconferencing session with a patient. The clinician may use teleprompter 1121 and teleprompter box inside to provide an eye contact impression to the patient. As described above, the clinician can control all remote cameras and can use observational camera to see either patient body or patient response in tablet 1122. The patient station 1130 illustrates two cameras used in the session: face-to-face camera 1131 and observational camera 1132. However, it is to be understood that, if desired, additional or fewer cameras can be employed in alternative aspects. The tablet 1133 is used to present stimuli and to capture patient responses. In the patient station 1140, a patient can touch a stimulus and may use pen to draw or to trace a pattern as shown.

FIG. 11 illustrates extensibility of the innovation to different cameras and medical devices. A retinal camera is used by a clinician to observe a patient's eye 1110 and the remote clinician can see the patient's eye and take an image snapshot of the eye 1120 for diagnostic documentation.

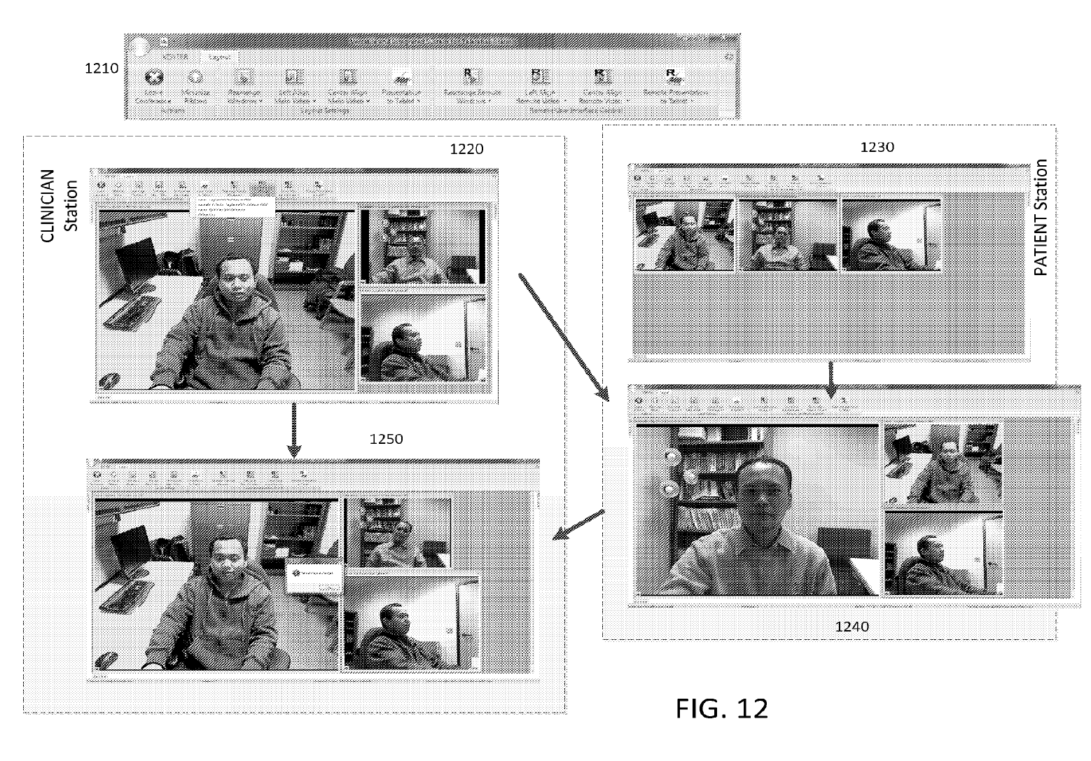

FIG. 12 illustrates the capability for controlling remotely the screen layout. In this illustration 1210 is of the system's ribbon menu for screen layout control and stimuli presentation. Using this menu, the clinician can remotely control the layout of the patient station as well as sending stimuli, e.g., to a tablet. The clinician can select (e.g., click) a remote patient control application 1220 to change the layout on the patient station, e.g., from 1230 (three video stream in a row) into 1240 (one large focus on the video of the clinician and put it on the left). Once complete, the system can send a message that the screen layout on the patient station has been changed, as illustrated in 1250.

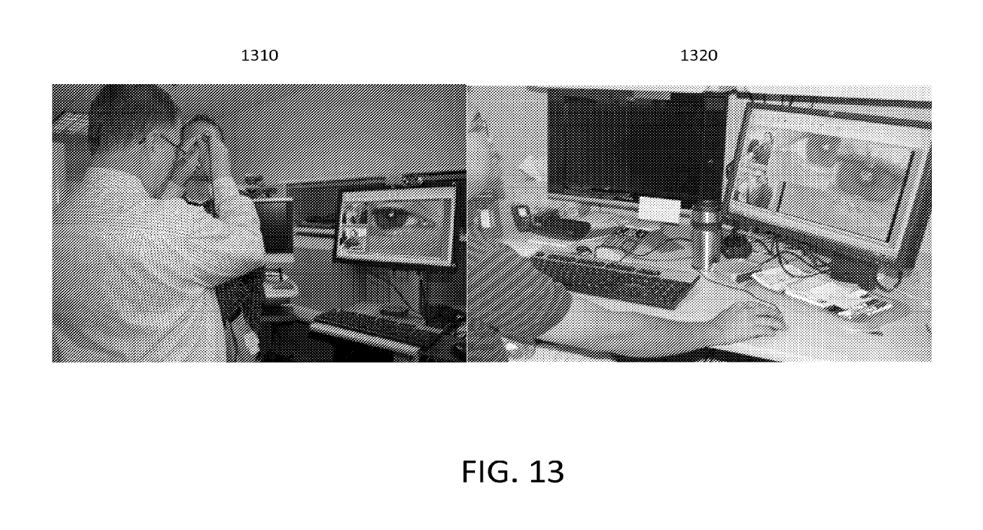

As illustrated in FIG. 13, a retinal camera can be employed at a patient station 1310 to capture image data which can be assessed at a clinician station 1320. It is to be appreciated that, as shown, a medical professional can be present at the patient station to administer procedures, etc. Additionally, as described supra, while only two stations are illustrated in FIG. 13, other aspects can employ additional stations (e.g., clinician stations) without departing from the spirit and/or scope of the innovation. This extensibility or expandability is to be included within this specification and claims appended hereto.

As shown in FIG. 13, examples of the application of this scenario include a resident in an ER (emergency room) (1310) consulting with a remote ophthalmologist (1320). Using this system, the remote ophthalmologist is able to see the inside of the patient's eye, at the same time observing if the resident is performing the exam correctly.

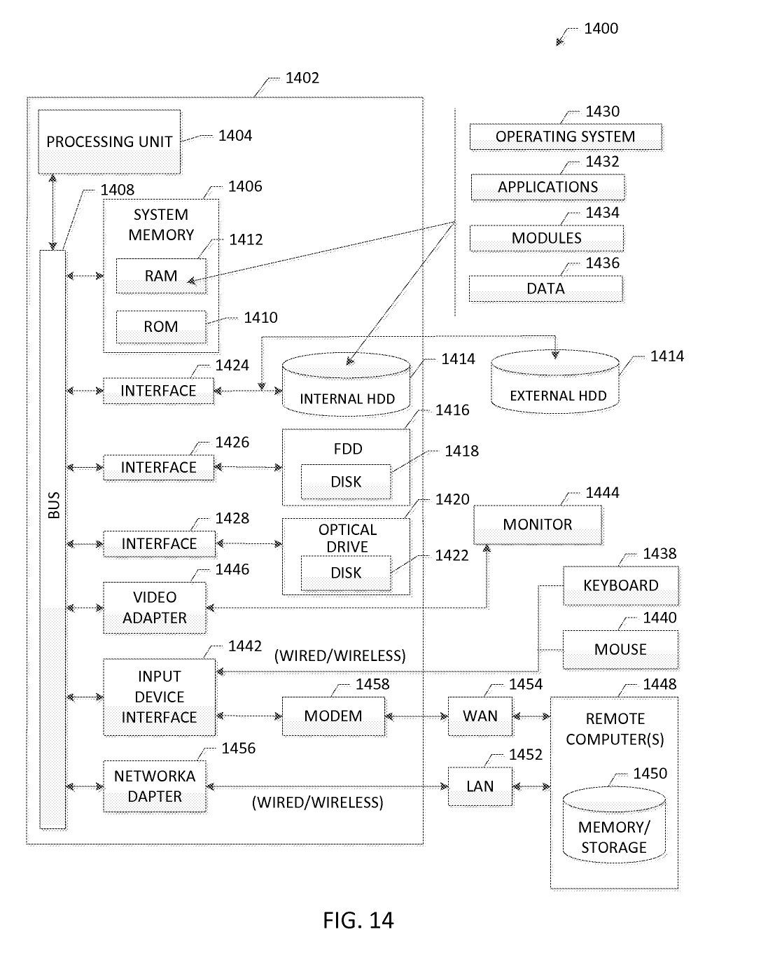

Referring now to FIG. 14, there is illustrated a block diagram of a computer operable to execute the disclosed architecture. In order to provide additional context for various aspects of the subject innovation, FIG. 14 and the following discussion are intended to provide a brief, general description of a suitable computing environment 1400 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 14, the exemplary environment 1400 for implementing various aspects of the innovation includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures may also be employed as the processing unit 1404.

The system bus 1408 can be any of several types of bus structure that may further interconnect to a memory bus (with or without a memory controller), a peripheral bus, and a local bus using any of a variety of commercially available bus architectures. The system memory 1406 includes read-only memory (ROM) 1410 and random access memory (RAM) 1412. A basic input/output system (BIOS) is stored in a non-volatile memory 1410 such as ROM, EPROM, EEPROM, which BIOS contains the basic routines that help to transfer information between elements within the computer 1402, such as during start-up. The RAM 1412 can also include a high-speed RAM such as static RAM for caching data.

The computer 1402 further includes an internal hard disk drive (HDD) 1414 (e.g., EIDE, SATA), which internal hard disk drive 1414 may also be configured for external use in a suitable chassis (not shown), a magnetic floppy disk drive (FDD) 1416, (e.g., to read from or write to a removable diskette 1418) and an optical disk drive 1420, (e.g., reading a CD-ROM disk 1422 or, to read from or write to other high capacity optical media such as the DVD). The hard disk drive 1414, magnetic disk drive 1416 and optical disk drive 1420 can be connected to the system bus 1408 by a hard disk drive interface 1424, a magnetic disk drive interface 1426 and an optical drive interface 1428, respectively. The interface 1424 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1402, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. It is appreciated that the innovation can be implemented with various commercially available operating systems or combinations of operating systems.

A user can enter commands and information into the computer 1402 through one or more wired/wireless input devices, e.g., a keyboard 1438 and a pointing device, such as a mouse 1440. Other input devices (not shown) may include a microphone, an IR remote control, a joystick, a game pad, a stylus pen, touch screen, or the like. These and other input devices are often connected to the processing unit 1404 through an input device interface 1442 that is coupled to the system bus 1408, but can be connected by other interfaces, such as a parallel port, an IEEE 1394 serial port, a game port, a USB port, an IR interface, etc.

A monitor 1444 or other type of display device is also connected to the system bus 1408 via an interface, such as a video adapter 1446. In addition to the monitor 1444, a computer typically includes other peripheral output devices (not shown), such as speakers, printers, etc.

The computer 1402 may operate in a networked environment using logical connections via wired and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wired/wireless connectivity to a local area network (LAN) 1452 and/or larger networks, e.g., a wide area network (WAN) 1454. Such LAN and WAN networking environments are commonplace in offices and companies, and facilitate enterprise-wide computer networks, such as intranets, all of which may connect to a global communications network, e.g., the Internet.

When used in a LAN networking environment, the computer 1402 is connected to the local network 1452 through a wired and/or wireless communication network interface or adapter 1456. The adapter 1456 may facilitate wired or wireless communication to the LAN 1452, which may also include a wireless access point disposed thereon for communicating with the wireless adapter 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wired or wireless device, is connected to the system bus 1408 via the serial port interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

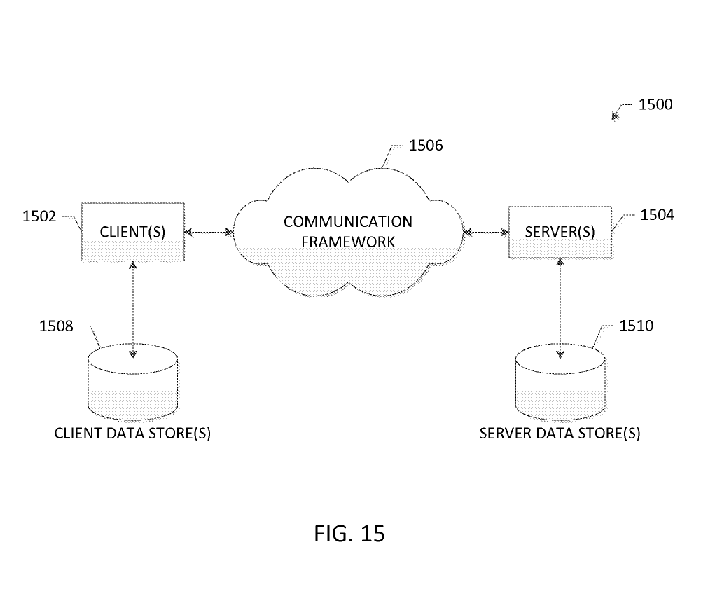

Referring now to FIG. 15, there is illustrated a schematic block diagram of an exemplary computing environment 1500 in accordance with the subject innovation. The system 1500 includes one or more client(s) 1502. The client(s) 1502 can be hardware and/or software (e.g., threads, processes, computing devices). The client(s) 1502 can house cookie(s) and/or associated contextual information by employing the innovation, for example.

The system 1500 also includes one or more server(s) 1504. The server(s) 1504 can also be hardware and/or software (e.g., threads, processes, computing devices). The servers 1504 can house threads to perform transformations by employing the innovation, for example. One possible communication between a client 1502 and a server 1504 can be in the form of a data packet adapted to be transmitted between two or more computer processes. The data packet may include a cookie and/or associated contextual information, for example. The system 1500 includes a communication framework 1506 (e.g., a global communication network such as the Internet) that can be employed to facilitate communications between the client(s) 1502 and the server(s) 1504.

Communications can be facilitated via a wired (including optical fiber) and/or wireless technology. The client(s) 1502 are operatively connected to one or more client data store(s) 1508 that can be employed to store information local to the client(s) 1502 (e.g., cookie(s) and/or associated contextual information). Similarly, the server(s) 1504 are operatively connected to one or more server data store(s) 1510 that can be employed to store information local to the servers 1504.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates telehealth, comprising:
a clinician station component communicatively coupled to a network;
a patient station component communicatively coupled to the network, wherein the clinician station facilitates remote configuration of at least one parameter of the patient station component, and wherein the first clinician station component and the patient station component facilitate a telehealth session capable of two-way communication.

2. The system of claim 1, wherein the telehealth session is one of a telerehabilitation session, telemedicine session, e-health, distant education session, or telehealthcare session.

3. The system of claim 1, wherein each of the clinician station component and the patient station component dynamically adjust to available bandwidth of the network.

4. The system of claim 1, wherein the network is one of an Internet, Internet 2, Wi-Fi network, Intranet, 4G network, 3G network, mobile phone network, multicast or unicast network.

5. The system of claim 1, wherein the at least one parameter is a perspective of a camera.

6. The system of claim 1, wherein the at least one parameter is a desktop layout.

7. The system of claim 1, further comprising an authentication component that regulates access of at least one of the clinician station component or the patient station component to a virtual telehealth room.

8. The system of claim 1, wherein an authenticated user can virtually lock the virtual telehealth room prohibiting access of additional individuals.

9. The system of claim 1, wherein each of the clinician station component and the patient station component comprises an application layer component, a capability layer component and a collaboration platform layer component.

10. The system of claim 9, wherein the clinician station component comprises integration with electronic health records or clinical collaboration portal.

11. The system of claim 9, wherein the clinician station component comprises a stimuli presentation and response capture component that enables a clinician to present stimuli to the patient station component and to capture stimuli responses in real time.

12. The system of claim 9, wherein a plug-and-play medical device and clinical camera can be attached to the clinician station component or the patient station component.

13. The system of claim 9, wherein the clinician station component comprises a remote layout management component that facilitates adjustment of the patient station component.

14. The system of claim 9, wherein the clinician station component comprises a session archive management component that facilitates retention of at least a portion of the telehealth session onto a secure telehealth server.

15. The system of claim 9, wherein the clinician station component comprises a capability to share clinical software applications or clinical materials with the patient station component.

16. The system of claim 9, wherein the clinician station component comprises a mechanism for locking a virtual clinical room.

17. The system of claim 9, wherein the clinician station component comprises an augmented interaction facility of at least one parameter embedded to video from the patient station component.

18. The system of claim 17, wherein the at least one parameter is the remote configuration of the camera perspective.

19. The system of claim 17, wherein the at least one parameter is a dynamic in-situ video annotation that enables a clinician to annotate video streams in real time.

20. The system of claim 17, wherein the at least one parameter is an image capture component that facilitates capture of a still image from a video stream of the telehealth session.

21. The system of claim 17, wherein the at least one parameter is a quick note component that enables a clinician to access and embed pre-designed or pre-written notes.

22. The system of claim 17, wherein the at least one parameter includes a teleprompter dialog component that enables a clinician to read protocol verbatim while maintaining eye contact impression with the patient.

23. A telehealth method, comprising:
authenticating a clinician station for entry into a virtual room;
authenticating a patient station for entry into a virtual room; and
electronically connecting the clinician station and the patient station in the virtual room, wherein the connection facilitates videoconferencing and telehealth-specific functionality.

24. The telehealth method of claim 16, further comprising virtually locking the virtual room to prohibit access.

25. The telehealth method of claim 16, wherein the clinician station remotely controls video equipment at the patient station.

26. The telehealth method of claim 16, further comprising providing stimuli to a patient station; and receiving real time response to the stimuli, wherein the response is used by a clinician in patient assessment.

27. A telehealth system, comprising:
means for establishing a virtual room;
means for communicatively connecting a clinician at a clinician station and a patient at a patient station into the virtual room;
means for locking the virtual room;
means for enabling the clinician to remotely control a camera at the patient station;
means for enabling the clinician to provide the patient with stimuli, wherein a response to the stimuli can be received in real time by the clinician; and
means for enabling the clinician to control desktop display layout at the patient station.
